(19) United States
(12) Patent Application Publication
(10) Pub. No.: US 2021/0008618 A1
(43) Pub. Date: Jan. 14, 2021

(54) FORMING METHOD OF METAL LAYER

(71) Applicant: Industrial Technology Research Institute, Hsinchu (TW)

(72) Inventors: Yi-Tsung Pan, Tainan City (TW); Jer-Young Chen, Hsinchu City (TW); Chuan-Sheng Chuang, Tainan City (TW); Shinn-Jen Chang, Hsinchu City (TW); Chi-San Chen, Kaohsiung City (TW); Li-Shing Chou, Tainan City (TW)

(73) Assignee: Industrial Technology Research Institute, Hsinchu (TW)

(21) Appl. No.: 17/033,934

(22) Filed: Sep. 28, 2020

Related U.S. Application Data
(63) Continuation-in-part of application No. 16/676,444, filed on Nov. 7, 2019.
(60) Provisional application No. 62/758,520, filed on Nov. 10, 2018.

(51) Int. Cl. B22F 3/10; B22F 3/105; B22F 1/00

(52) U.S. Cl. CPC B22F 3/1017; B22F 3/1007; B33Y 10/00; B22F 1/0059; B22F 3/1055

(57) ABSTRACT

Provided is a forming method of a metal layer suitable for a 3D printing process. The method includes the steps of (1) providing first metal particles on a substrate to form a first layer; (2) performing a first pre-heat treatment on the first layer; (3) applying an oxide-removing agent on selected first metal particles in the first layer to remove metal oxides; (4) providing second metal particles on the first layer to form a second layer; (5) performing a second pre-heat treatment on the second layer; (6) applying the oxide-removing agent on selected second metal particles in the second layer to remove metal oxides; repeating (1) to (6) until a latent part is formed; performing a first heat treatment on the first and second metal particles of the latent part to form a near shape; and performing a second heat treatment on the near shape to form a sintered body.

### CROSS-REFERENCE TO RELATED APPLICATION

This application is a continuation-in-part application of and claims the priority benefit of a prior application Ser. No. 16/676,444, filed on Nov. 7, 2019, now pending. The prior application Ser. No. 16/676,444 claims the priority benefit of U.S. provisional application Ser. No. 62/758,520, filed on Nov. 10, 2018. The entirety of each of the above-mentioned patent applications is hereby incorporated by reference herein and made a part of this specification.

### TECHNICAL FIELD

The disclosure relates to a forming method of a metal layer, and more particularly to a forming method of a metal layer suitable for a three-dimensional (3D) printing process.

### BACKGROUND

A layer of metal oxides is inevitably generated on the surface of the metal particles due to oxygen in the external environment. Since the metal oxides have a higher melting point than the metal, the heat treatment has to be performed at a higher temperature. In a general 3D printing process, after metal particles are provided on a substrate, the metal particles are heat-treated to form a dense sintered body of the metal particles to form a metal layer. A layer of metal oxides is inevitably generated on the surface of the metal particles due to oxygen in the external environment. Since the metal oxides have a higher melting point than the metal, the heat treatment has to be performed at a higher temperature.

At present, metal particles having a metal oxide layer formed on the surface are mostly heat-treated by high-energy laser. The high-energy laser may simultaneously melt the metal oxide layer and the metal particles. However, the sintered body thus formed contains metal oxides, thus affecting the characteristics of the resulting metal layer.

### SUMMARY

The disclosure provides a forming method of a metal layer utilizing an oxide-removing agent to remove metal oxides on metal particles prior to high-temperature sintering.

The forming method of a metal layer of the disclosure is suitable for a 3D printing process and includes the following steps. A plurality of metal particles are provided on a substrate. An oxide-removing agent is applied to the metal particles to remove metal oxides on the metal particles. At a first temperature, a first heat treatment is performed on the metal particles for which the metal oxides are removed to form a near shape. At a second temperature, a second heat treatment is performed on the near shape to form a sintered body. The first temperature is lower than the second temperature.

The forming method of a metal layer of the disclosure is suitable for a 3D printing process and includes the following steps: (1) providing a plurality of first metal particles on a substrate to form a first layer of the plurality of first metal particles; (2) performing a first pre-heat treatment on the first layer at a first pre-heat temperature; (3) applying an oxide-removing agent on selected first metal particles in the first layer to remove metal oxides on the selected first metal particles after providing the plurality of first metal particles on the substrate; (4) providing a plurality of second metal particles on the first layer to form a second layer of the plurality of second metal particles, wherein the second layer is farther away from the substrate than the first layer; (5) performing a second pre-heat treatment on the second layer at a second pre-heat temperature; (6) applying the oxide-removing agent on selected second metal particles in the second layer to remove metal oxides on the selected second metal particles; repeating (1) to (6) until a latent part is formed; performing a first heat treatment on the first and second metal particles of the latent part for which the metal oxides are removed at a first temperature to form a near shape; and performing a second heat treatment on the near shape at a second temperature to form a sintered body. The first temperature is lower than the second temperature.

In an embodiment of the disclosure, after the metal particles are provided on the substrate, the metal oxides on the metal particles are removed with an oxide-removing agent, and thus a near shape may be formed after a low-temperature heat treatment. As a result, the time for a subsequent high-temperature heat treatment may be effectively shortened, and a sintered body of high purity may be formed.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a flowchart of the steps of a forming method of a metal layer shown according to a first embodiment of the disclosure.

FIG. 2A to FIG. 2C are cross-sectional views of a process of a forming method of a metal layer shown according to the first embodiment of the disclosure.

FIG. 3A, FIG. 3B, and FIG. 3C are the results of low-temperature calcination of stainless-steel particles of the experimental examples and the comparative example.

FIG. 4A to FIG. 4D are cross-sectional views of a process of a forming method of a metal layer shown according to a second embodiment of the disclosure.

### DETAILED DESCRIPTION OF DISCLOSED EMBODIMENTS

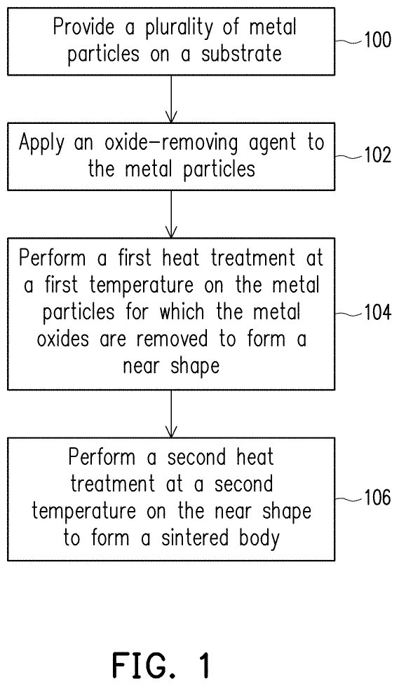

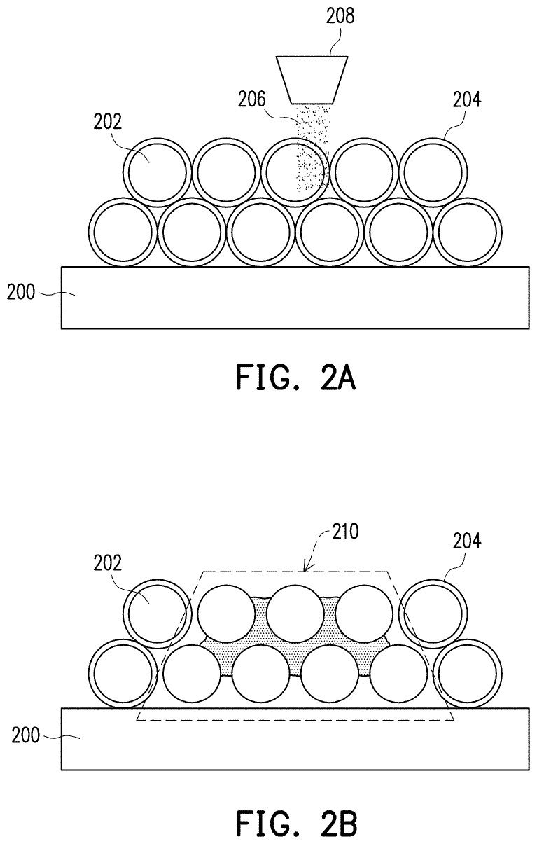

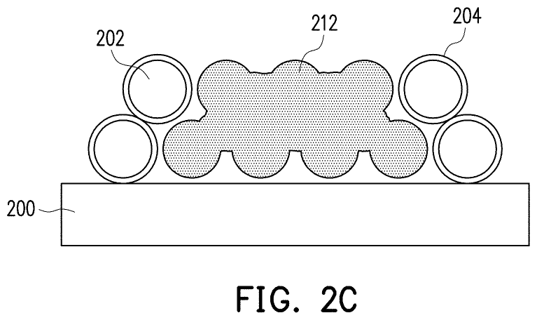

FIG. 1 is a flowchart of the steps of a forming method of a metal layer shown according to an embodiment of the disclosure. FIG. 2A to FIG. 2C are cross-sectional views of a process of a forming method of a metal layer shown according to an embodiment of the disclosure. Referring to FIG. 1 and FIG. 2A simultaneously, in step 100, a plurality of metal particles 202 are provided on a substrate 200. The substrate 200 may be various substrates on which a metal layer is to be formed, and the disclosure is not limited in this regard. The metal particles 202 may also be referred to as metal powders, and the material thereof may be a metal or an alloy. In the present embodiment, the metal particles 202 may be aluminum particles, stainless-steel particles, tin particles, titanium particles, zinc particles, magnesium particles, zirconium particles, or chromium particles, but the disclosure is not limited thereto. In the present embodiment, the method of providing the metal particles 202 on the substrate 200 is, for example, a process such as inkjet, spraying, or micro-dispensing, but the disclosure is not limited thereto.

Generally, after the metal particles 202 are provided on the substrate 200, a layer of metal oxides 204 is generated on the surface of the metal particles 202 due to the oxidation of oxygen in the external environment.

Then, in step 102, an oxide-removing agent 206 is applied to the metal particles 202 to remove the metal oxides 204 on the metal particles 202. In the present embodiment, the oxide-removing agent 206 is, for example, an organic acid, an inorganic acid, a flux, or carbon particles. The organic acid is, for example, oxalic acid, acetic acid, citric acid, or a combination thereof. The inorganic acid is, for example, phosphoric acid, sulfuric acid, or a combination thereof. When carbon particles are used as the oxide-removing agent 206, the carbon particles need to be applied to the metal particles 202 under a hydrogen atmosphere to reduce the metal oxides 204 on the metal particles 202 to a metal. A suitable oxide-removing agent 206 may be selected depending on the type of the metal particles 202. For example, when the metal particles 202 are stainless-steel particles, oxalic acid is selected as the oxide-removing agent 206 to effectively remove the oxides from the stainless-steel particles. Further, when the metal oxides 204 on the metal particles 202 are removed by the oxide-removing agent 206, the impurities attached to the metal particles 202 are also removed at the same time. As a result, the sintered body formed in a subsequent step does not contain metal oxides and impurities, and a metal sintered body having high purity may be formed.

The oxide-removing agent 206 may be applied to the metal particles 202 in a variety of ways. For example, the oxide-removing agent 206 may be applied to the metal particles 202 using inkjet, micro-dispensing, or spraying. In the present embodiment, the oxide-removing agent 206 may be applied to the metal particles 202 by a nozzle 208. Further, in the above manner, the oxide-removing agent 206 may be applied to the metal particles 202 of a specific region or applied to all of the metal particles 202. As shown in FIG. 2A, the oxide-removing agent 206 may be applied to the metal particles 202 located in the intermediate region by the nozzle 208. In addition, when spraying is employed, the oxide-removing agent 206 may be applied to the metal particles 202 over a large area. Therefore, the metal oxides 204 on the metal particles 202 may be quickly removed. Additionally, for specific oxide-removing agents, the metal oxides need to be removed at a particular activation temperature. Therefore, the treatment temperature is raised to the above activation temperature during the application of the oxide-removing agent.

Next, referring to FIG. 1 and FIG. 2B simultaneously, in step 104, the metal particles 202 for which the metal oxides 204 are removed are heat-treated at a first temperature to form a near shape 210. The first temperature depends on the material of the metal particles 202, and the disclosure is not limited thereto. In detail, after the metal oxides 204 on the metal particles 202 are removed using the oxide-removing agent 206, the metal particles 202 are exposed. Therefore, the metal oxides 204 may not be melted using a high-temperature heat treatment, and the metal particles 202 may be directly subjected to a low-temperature heat treatment to form the near shape 210. During the low-temperature heat treatment, a necking effect is generated between the metal particles 202 (this step may be referred to as low-temperature calcination), and the shape of the metal layer formed at this time is referred to as a near shape. Therefore, the metal particles are first formed into a near shape by a low-temperature heat treatment to shorten the time of subsequent high-temperature sintering.

In particular, when the oxide-removing agent needs to remove the metal oxides at the activation temperature, the activation temperature is typically lower than the first temperature. Further, in some embodiments, after the metal oxides are removed at the activation temperature, the temperature may be directly raised from the activation temperature to the first temperature to continuously perform the heating.

Next, referring to FIG. 1 and FIG. 2C simultaneously, in step 106, a second heat treatment is performed at a second temperature higher than the first temperature, so that the near shape 210 is formed into the sintered body 212 having a dense structure. The second temperature depends on the material of the metal particles 202, and the disclosure is not limited thereto. In the present embodiment, the second heat treatment may be performed using low-energy laser, an oven, or an electron beam (this step may be referred to as high-temperature sintering). Since in step 104, the metal particles 202 first generate a link effect at a lower first temperature to form the near shape 210, in step 106, the sintering time at a higher second temperature may be shortened and the resulting dense sintered body 212 does not have metal oxides and impurities and has high purity. As a result, the metal layer formed by the sintered body 212 of the present embodiment may have stable and desirable characteristics.

The effects of the forming method of a metal layer of the disclosure are described below by experimental examples and a comparative example.

### Experimental Example 1

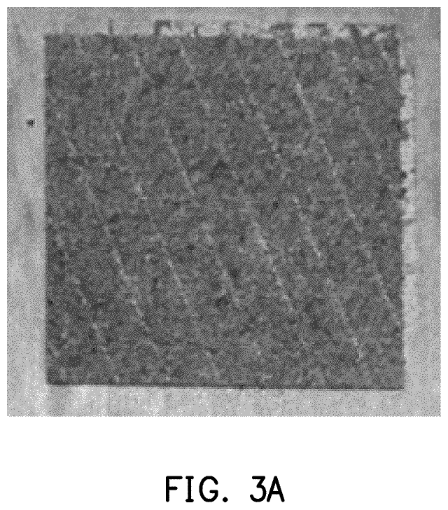

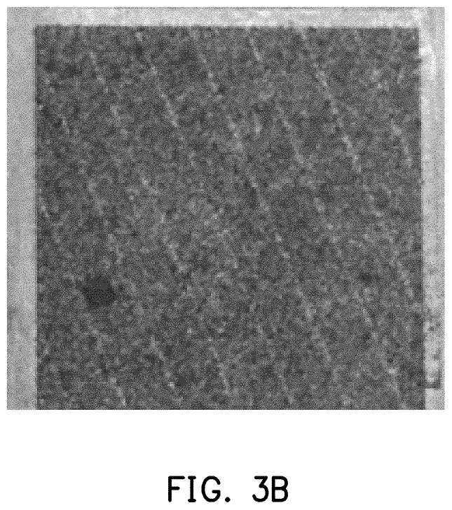

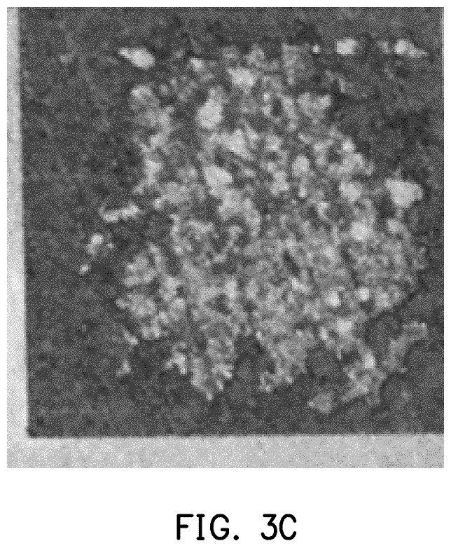

Stainless-steel particles were used as metal particles, and after being provided on a substrate, oxalic acid (pH about 2) was used as an oxide-removing agent to remove oxides on the stainless-steel particles (melting point about 1565° C.), then low-temperature calcination was performed at 800° C. to generate a link effect between the stainless-steel particles to form a near shape, and the result is shown in FIG. 3A.

### Experimental Example 2

Stainless-steel particles were used as metal particles, and after being provided on a substrate, flux (potassium fluoroborate, KBF₄) was used as an oxide-removing agent to remove oxides on the stainless-steel particles, then low-temperature calcination was performed at 800° C. to generate a link effect between the stainless-steel particles to form a near shape, and the result is shown in FIG. 3B.

### Comparative Example 1

Stainless-steel particles were used as metal particles, and after being provided on a substrate, low-temperature calcination was directly performed at 800° C. At this time, a link effect could not be generated, and the result is shown in FIG. 3C.

As may be seen from FIG. 3A, FIG. 3B, and FIG. 3C, the oxides on the stainless-steel particles were removed with the oxide-removing agent after the stainless-steel particles were provided on the substrate, so that a link effect may be formed after the low-temperature heat treatment (as shown in FIG. 3A and FIG. 3B), and stainless-steel particles for which oxides were not removed using the oxide-removing agent could not form a link effect after the low-temperature heat treatment (as shown in FIG. 3C). As a result, in Experimental example 1 and Experimental example 2, since the near shape was formed first, the time for the subsequent high-temperature heat treatment to form a sintered body may be shortened, and a sintered body of high purity may be formed.

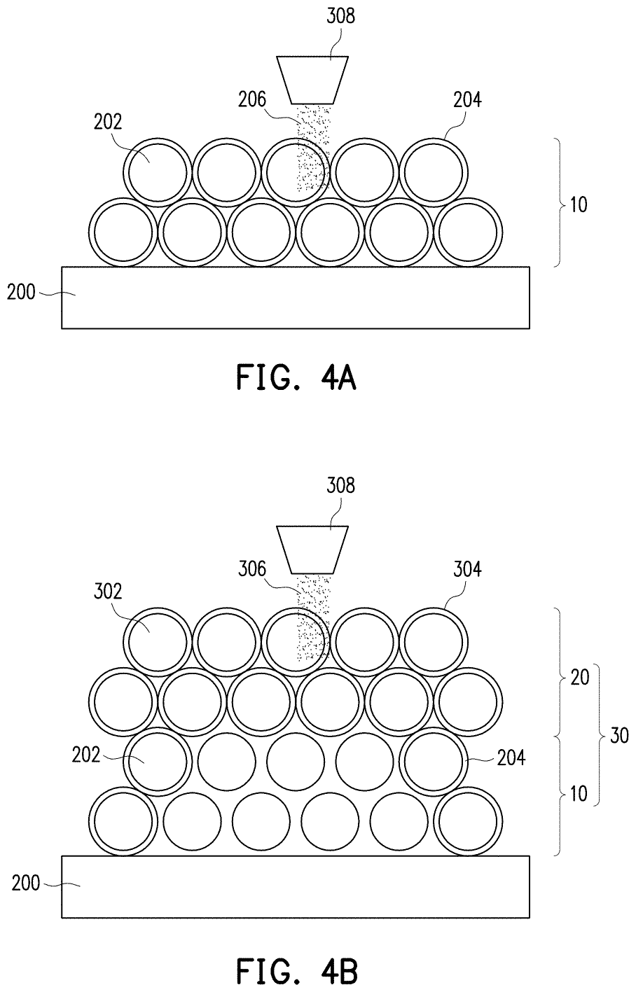

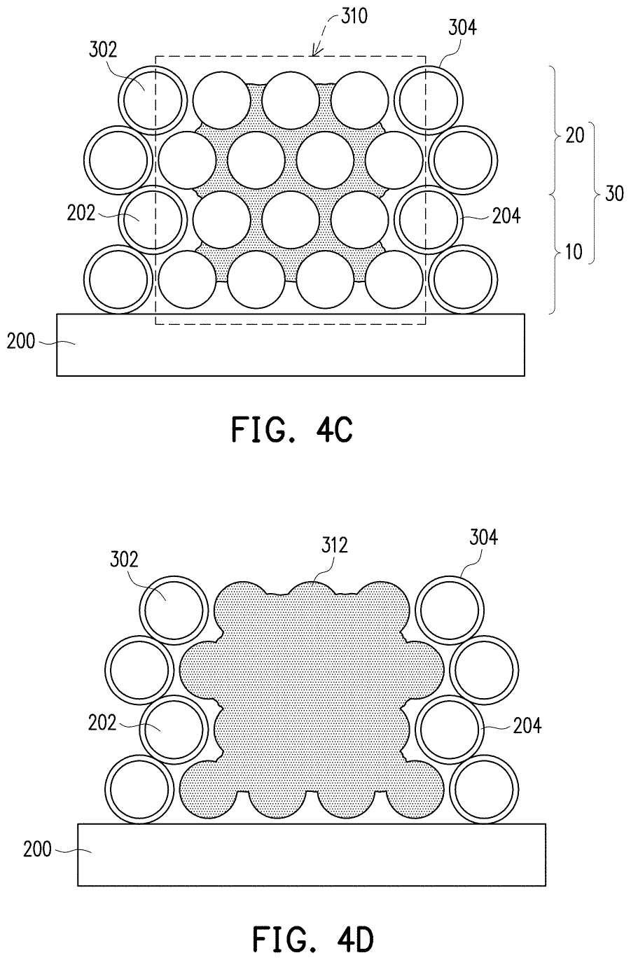

FIG. 4A to FIG. 4D are cross-sectional views of a process of a forming method of a metal layer shown according to a second embodiment of the disclosure. In the present embodiment, the same components as those in the first embodiment will be denoted by the same reference numbers and will not be described again.

Referring to FIG. 4A, a plurality of metal particles 202 are provided on the substrate 200 to form a first layer 10 of the plurality of metal particles 202, as shown in FIG. 2A. After the metal particles 202 are provided on the substrate 200, a layer of metal oxides 204 is generated on the surface of the metal particles 202 due to the oxidation of oxygen in the external environment. Then, a first pre-heat treatment is performed on the first layer 10 at a first pre-heat temperature to 200° C. In the present embodiment, the first pre-heat temperature is between 150° C. and 250° C.

Next, the oxide-removing agent 206 is applied to the selected metal particles 202 to remove the metal oxides 204 on the selected metal particles 202. In the present embodiment, the selected metal particles 202 are the metal particles in the intermediate region of the first layer 10, but the disclosure is not limited thereto. The oxide-removing agent 206 may be applied to the metal particles 202 in a variety of ways, as described above. For example, the oxide-removing agent 206 may be applied to the metal particles 202 using inkjet, micro-dispensing, or spraying. In the present embodiment, the oxide-removing agent 206 may be applied to the metal particles 202 using the inkjet 308. The inkjet 308 may be implemented by a direct inkjet printing system for fabricating a part by an additive manufacturing process. The direct inkjet printing system performs a drop-on-demand inkjet printing process. The direct inkjet printing system includes a print head for applying an inkjet ink as the oxide-removing agent 206 onto the substrate 200. Further, the inkjet ink may be a water-based ink. In the present embodiment, the inkjet ink as the oxide-removing agent 206 may contain an oxide-removing agent dispersion containing from about 1 to about 25 parts of potassium fluoroborate (KBF₄), an aqueous carrier medium containing from about 70 to about 95 parts of water, a humectant such as ethylene glycol, diethylene glycol or propylene glycol from about 0.5 to about 20 parts, and a wetting agent such as BYK-333, BYK-348, BYK-3455, BYK-DYNWET 800 N from about 0.01 to about 10 parts. The inkjet ink may have a viscosity about 2 to about 25 cp at a predetermined working temperature.

Referring to FIG. 4B, a plurality of metal particles 302 are provided on the first layer 10 in the same or similar way as metal particles 202 to form a second layer 20 of the plurality of metal particles 302. As a result, the second layer 20 is farther away from the substrate 200 than the first layer 10. As the metal particles 202, the metal particles 302 may also be referred to as metal powders, and the material thereof may be a metal or an alloy. The metal particles 302 may be aluminum particles, stainless-steel particles, tin particles, titanium particles, zinc particles, magnesium particles, zirconium particles, or chromium particles, but the disclosure is not limited thereto. In the present embodiment, the method of providing the metal particles 302 on the first layer 10 is, for example, a process such as inkjet, spraying, or micro-dispensing, but the disclosure is not limited thereto. In the present embodiment, the metal particles 302 are the same as the metal particles 202, but the disclosure is not limited thereto. After the metal particles 302 are provided on the first layer 10, a layer of metal oxides 304 is generated on the surface of the metal particles 302 due to the oxidation of oxygen in the external environment. Depending on the metal particles 302, the metal oxides 304 may be the same as or different from the metal oxides 204. In the present embodiment, the metal oxides 304 are the same as the metal oxides 204, but the disclosure is not limited thereto. Then, a second pre-heat treatment is performed on the second layer 20 at a second pre-heat temperature to 200° C. In the present embodiment, the second pre-heat temperature is between 150° C. and 250° C.

Next, an oxide-removing agent 306 is applied to the selected metal particles 302 in the same or similar way as the oxide-removing agent 206 to remove the metal oxides 304 on a selected metal particles 302. For example, the oxide-removing agent 306 may be applied to the metal particles 302 using inkjet, micro-dispensing, or spraying. As described above, the oxide-removing agent 306 may be applied to the metal particles 302 of a specific region or applied to all of the metal particles 302. In the present embodiment, the oxide-removing agent 306 may be applied to the metal particles 302 using the inkjet 308. In the present embodiment, the selected metal particles 302 are the metal particles in the intermediate region of the second layer 20, but the disclosure is not limited thereto. In addition, when spraying is employed, the oxide-removing agent 306 may be applied to the metal particles 302 over a large area. Therefore, the metal oxides 304 on the metal particles 302 may be quickly removed. Additionally, for specific oxide-removing agents, the metal oxides need to be removed at a particular activation temperature. Therefore, the treatment temperature is raised to the above activation temperature during the application of the oxide-removing agent.

In the present embodiment, only the first layer 10 and the second layer 20 are formed to form a latent part on the substrate 100, but the disclosure is not limited thereto. In other embodiment, the steps described in FIGS. 4A and 4B may be repeated until a needed latent part is formed on the substrate 100.

Next, referring to FIG. 4C, the metal particles 202 and 302 of the latent part for which the metal oxides 204 and 304 are removed are heat-treated at a first temperature to form a near shape 310. The first temperature depends on the material of the metal particles 202 and 302, and the disclosure is not limited thereto. In detail, after the metal oxides 204 on the metal particles 202 are removed using the oxide-removing agent 206 and the metal oxides 304 on the metal particles 302 are removed using the oxide-removing agent 306, the metal particles 202 and 302 are exposed. Therefore, the metal oxides 204 and 304 may not be melted using a high-temperature heat treatment, and the metal particles 202 and 302 may be directly subjected to a low-temperature heat treatment to form the near shape 310. During the low-temperature heat treatment, a necking effect is generated between the metal particles 202 and 302 (this step may be referred to as low-temperature calcination), and the shape of the metal layer formed at this time is referred to as a near shape. Therefore, the metal particles are first formed into a near shape by a low-temperature heat treatment to shorten the time of subsequent high-temperature sintering.

In particular, when the oxide-removing agents need to remove the metal oxides at the activation temperature, the activation temperature is typically lower than the first temperature. Further, in some embodiments, after the metal oxides are removed at the activation temperature, the temperature may be directly raised from the activation temperature to the first temperature to continuously perform the heating.

Next, referring to FIG. 4D, a second heat treatment is performed at a second temperature higher than the first temperature, so that the near shape 310 is formed into the sintered body 312 having a dense structure. The second heat treatment may be performed in a vacuum environment or an inert environment. The second temperature depends on the material of the metal particles 202 and 302, but the disclosure is not limited thereto. The second temperature may be between 1523 K and 1698 K. In the present embodiment, the second heat treatment may be performed using low-energy laser, an oven, or an electron beam (this step may be referred to as high-temperature sintering). Since the metal particles 202 and 302 first generate a link effect at a lower first temperature to form the near shape 310, the sintering time at a higher second temperature may be shortened and the resulting dense sintered body 312 does not have metal oxides and impurities and has high purity. As a result, the metal layer formed by the sintered body 312 of the present embodiment may have stable and desirable characteristics.

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A forming method of a metal layer suitable for a 3D printing process, comprising the following steps:
(1) providing a plurality of first metal particles on a substrate to form a first layer of the plurality of first metal particles;
(2) performing a first pre-heat treatment on the first layer at a first pre-heat temperature;
(3) applying an oxide-removing agent on selected first metal particles in the first layer to remove metal oxides on the selected first metal particles after providing the plurality of first metal particles on the substrate;
(4) providing a plurality of second metal particles on the first layer to form a second layer of the plurality of second metal particles, wherein the second layer is farther away from the substrate than the first layer;
(5) performing a second pre-heat treatment on the second layer at a second pre-heat temperature;
(6) applying the oxide-removing agent on selected second metal particles in the second layer to remove metal oxides on the selected second metal particles;
repeating (1) to (6) until a latent part is formed;
performing a first heat treatment on the first and second metal particles of the latent part for which the metal oxides are removed at a first temperature to form a near shape; and
performing a second heat treatment on the near shape at a second temperature to form a sintered body,
wherein the first temperature is lower than the second temperature.

2. The forming method of the metal layer of claim 1, wherein the oxide-removing agent comprises an organic acid, an inorganic acid, a flux, or carbon particles.

3. The forming method of the metal layer of claim 2, wherein the organic acid comprises oxalic acid, acetic acid, citric acid, or a combination thereof.

4. The forming method of the metal layer of claim 2, wherein the inorganic acid comprises phosphoric acid, sulfuric acid, or a combination thereof.

5. The forming method of the metal layer of claim 2, wherein the carbon particles are applied to the metal particles in a hydrogen atmosphere.

6. The forming method of the metal layer of claim 1, wherein a method of applying the oxide-removing agent comprises inkjet, micro-dispensing, or spraying.

7. The forming method of the metal layer of claim 6, wherein the inkjet is implemented by a direct inkjet printing system for fabricating a part by an additive manufacturing process.

8. The forming method of the metal layer of claim 7, wherein the direct inkjet printing system performs a drop-on-demand inkjet printing process and comprises a print head for applying an inkjet ink onto the substrate.

9. The forming method of the metal layer of claim 8, wherein the inkjet ink is a water-based ink.

10. The forming method of the metal layer of claim 1, wherein a material of the first and second metal particles comprises a metal or an alloy.

11. The forming method of the metal layer of claim 1, further comprising applying the oxide-removing agent to the first and/or second metal particles at an activation temperature of the oxide-removing agent, and the activation temperature is lower than the first temperature.

12. The forming method of the metal layer of claim 11, further comprising directly increasing a temperature to the first temperature at the activation temperature after the metal oxides on the first and second metal particles are removed.

13. The forming method of the metal layer of claim 1, wherein the second heat treatment is performed in a vacuum environment or an inert environment.

14. The forming method of the metal layer of claim 1, wherein the second temperature is between 1523 K and 1698 K.
